(19) United States
(12) Patent Application Publication
(10) Pub. No.: US 2012/0145250 A1
(43) Pub. Date: Jun. 14, 2012

(54) SANITARY VALVE EQUIPMENT

(75) Inventors: Bernd Werner, Rottweil-Hausen (DE); Hubert Schmitt, Hausach (DE)

(73) Assignee: Hansgrohe AG, Schiltach (DE)

(21) Appl. No.: 13/311,732

(22) Filed: Dec. 6, 2011

(30) Foreign Application Priority Data
Dec. 9, 2010 (DE) 102010062754.2

(51) Int. Cl. F16K 17/38

(52) U.S. Cl. 137/2; 137/468

(57) ABSTRACT

The invention proposes a sanitary valve device in which a temperature limiting valve is used to protect a user from water that is too cold. The valve device is designed such that when a water outlet, for example a shower, is switched on, the water is first passed through a first water duct containing the temperature limiting valve, in which duct the temperature limiting valve permits the passage of water below a limit temperature, but blocks it off when above the limit temperature. The fact that either no water or a heavily reduced quantity of water is discharged from the outlet of the sanitary fitting indicates to the user that the cold water has flowed away. He can now operate the changeover valve to directly draw hot water, the temperature limiting valve now being switched off.

The invention is based on valve equipment for sanitary fittings having a temperature limiting valve.

Sanitary equipment in households may contain thermostatic valves whose purpose is to maintain the temperature of mixed water at a particular value. This is so that during showering or washing a user does not shower or wash with water that is too hot. Usually thermostats of this type also incorporate a limiter so that the maximum value cannot be set too high. Sometimes, however, this limit can be overridden by a special mode of operation.

There are also limiting valves which, for safety reasons, interrupt the flow of water when a specific temperature is exceeded.

When showers are used, the water contained in the pipes, which is usually cold at first, is discharged first. Cold water therefore flows out until the hot water gradually follows it. Thermostatic valves are not able to prevent cold water from being discharged, since thermostatic valves can only provide a mixing temperature.

A temperature-controlled valve used as an additional element is already known, and can, for example, be connected to the outlet of a sanitary valve and allows the cold water discharged at first to flow through it until the following water becomes hot. This temperature-controlled valve then closes the outlet. With the aid of a supplementary element, the initially closed valve seat of this valve can be released, so that it moves and the flow of water through the very same valve is opened again. In this way, the user is able to detect when the water flowing through has become hot. When, following the shower, or indeed when no shower is being taken, the water has become cold again, the temperature-controlled valve returns to its initial position (EP 1841991).

The object underlying the invention is to provide a way of preventing a user from being startled by water that is still cold when showering or washing.

To fulfil this task, the invention proposes a sanitary valve device with the features described in claim 1. Further developments of the invention are the subject of dependent claims.

The sanitary valve device proposed by the invention thus contains a changeover valve, operated manually for example, having two inlets and one outlet, or vice versa. In either position of the changeover valve, the mixed water inlet is connected to the outlet from the valve device by one of the two water ducts.

If the changeover valve is moved, for example manually, into the position corresponding to the continuous passage of water, i.e. without the temperature limiting valve, then the water will flow from the mixed water inlet directly through to the outlet.

If the changeover valve is moved into the position corresponding to the second water duct, then the water continues to flow out for until it has reached the limit temperature. The temperature limiting valve employed in this water duct is designed such that when the water temperature is below, for example, 40°, it holds the water duct open, and that when this water temperature is reached it substantially completely closes the water duct.

The user can, however, interrupt operation of the temperature limiting valve at any time by operating the changeover valve.

The outlet from the changeover valve is, for example, connected to the outlet of the valve device. The outlet from the valve device can lead, directly or via a pipe, to a water outlet from a sanitary fitting. One inlet into the changeover valve is connected via the first water duct to the mixed water inlet into the valve device. The second inlet into the changeover valve is supplied with water coming from the mixed water inlet via a second water duct, the temperature limiting valve here being located in this second water duct.

It is however also possible for the changeover valve to be positioned upstream of the two water ducts.

The sanitary valve devices proposed by the invention can, for example, be positioned at the end of a pipe, where, due to the two water ducts, a doubling unit that creates two water ducts must be located at least one place in the pipe. This could, for example, be in the handle of a hand shower. Then, when the limit temperature of, for example, 40° is reached, an actuating element for the changeover valve can also serve as a type of switch-on button.

It is however particularly helpful for the sanitary valve device to be incorporated into a sanitary fitting where a mixer valve that includes a mixed water outlet is already located. This mixed water outlet from the mixer valve then forms the mixed water inlet to the valve device, or is connected thereto.

Any valve that is controlled in response to temperature may be suitable as the temperature limiting valve, although a valve of this type is preferable due to the widespread availability of mechanically operating valves incorporating an expansion body. A spring can be used to ensure that the valve is reset again when the temperature falls.

In a further development, it has been found particularly helpful if the temperature limiting valve does not completely block the flow when in its closed state. As a result, a small residual quantity of water continues to flow through this water duct even when the limit temperature has been reached. When the valve is closed, this small flow of water draws the user's attention to the fact that, on the one hand, the water flow is turned on and, on the other hand, that it contains hot water. In addition, the low water flow has the advantage that the temperature limiting valve continues to be affected by hot water, so that it does not open again after a certain period of time, so that a renewed floe of hot water out of the pipe follows relatively quickly, as this could lead to continuous opening and closing of the valve.

According to the invention it is possible to arrange for the two water ducts to be completely separate from one another, so that the direct flow of water between the mixed water inlet and the changeover valve does not therefore pass through the temperature limiting valve.

In yet another further development of the invention, it is possible that the valve closing surface of the temperature limiting valve is the enclosing surface of a cylinder. The valve closing surface of the temperature limiting valve verse slides, for example, into a hole, from whose enclosing surface a channel leads to the inlet of the changeover valve.

The invention also proposes the use of a temperature limiting valve to safeguard against temperatures that are too low in a sanitary valve device, as is described here.

Further features, details and advantages of the invention are shown in the claims and in the abstract, the wordings of both of which are made into the substance of the description by reference, in the following description of a preferred embodiment, and by the drawing. The drawing shows in:

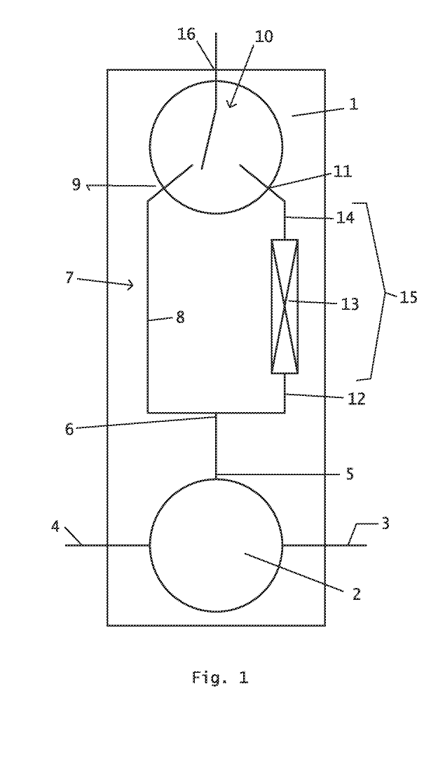

FIG. 1 a schematic illustration of the flow in the valve device proposed by the invention;

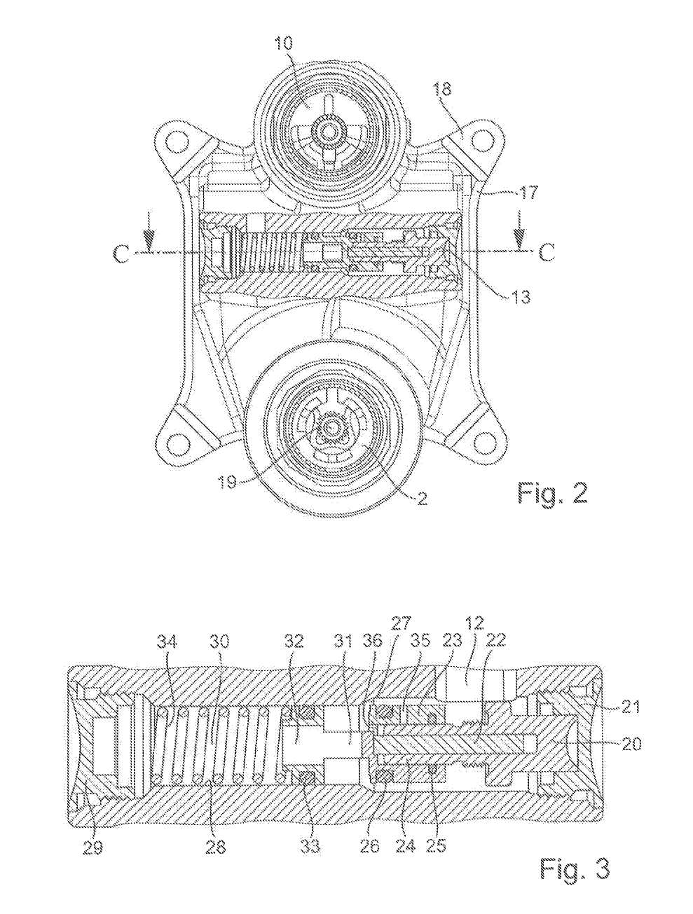

FIG. 2 a partially cut away plan view of a sanitary fitting;

FIG. 3 a section along the line C-C of FIG. 2;

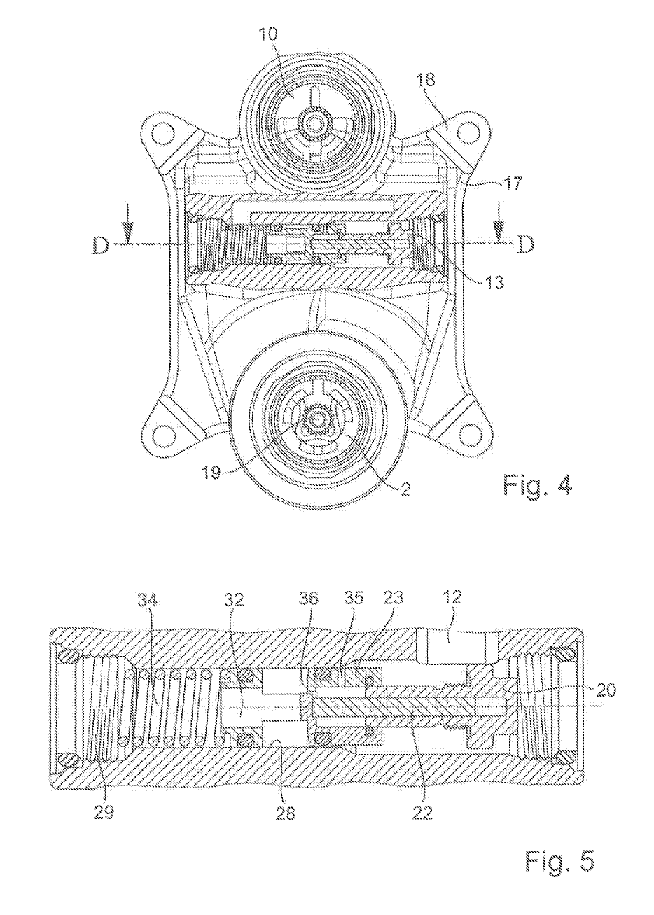

FIG. 4 a partially cut-away plan view of the sanitary fitting in which the temperature limiting valve is closed;

FIG. 5 a section corresponding to that of FIG. 3 along the line DD of FIG. 4;

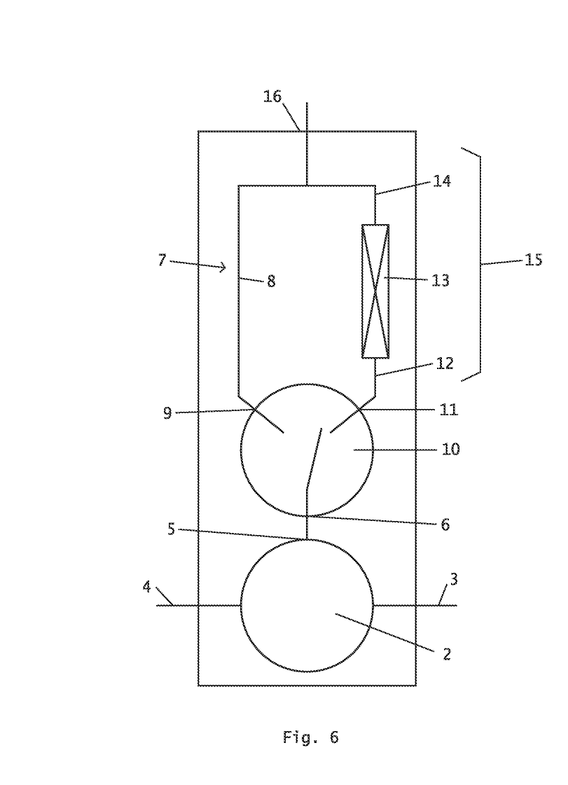

FIG. 6 a schematic illustration corresponding to that of FIG. 1 in a second embodiment.

We consider first FIG. 1, which shows a schematic illustration of the flows in the valve device proposed by the invention. A sanitary fitting 1 contains a mixer valve 2, for example a single-lever mixing valve. The mixer valve 2 has a connection for a pipe 3 through which the cold water flows into the inlet for cold water. The mixer valve 2 has a further connection for a second pipe 4 through which the hot water flows into the inlet for hot water. A mixture with a mixing temperature is created in the water in the mixing valve. The water having this mixing temperature flows out of the mixer valve 2 through a mixed water outlet 5. In the example illustrated, this mixed water outlet 5 simultaneously acts as a mixed water inlet 6 into the valve device. From this mixed water inlet 6, a channel 8 forming a first water duct 7 leads to an inlet 9 of a changeover valve 10. The changeover valve, which is represented symbolically in FIG. 1, has a second inlet 11. A second channel 12 leads from the mixed water inlet 6 into the valve device to a temperature limiting valve 13, whose outlet leads via a continuing channel 14 to a second inlet 11 of the changeover valve 10. The channels 12 and 14, together with the temperature limiting valve 13, comprise the second water duct 15.

In addition to the two inlets 9, 11, the changeover valve 10 has an outlet 16 that constitutes the outlet from the valve device or is connected thereto.

If the changeover valve 10 is in the position in which the inlet 11 is connected to the outlet 16, the water can flow out of the mixed water outlet 5 of the mixer valve 2 to the outlet 16 until the temperature of the mixed water is lower than the limit temperature of the temperature limiting valve.

If, on the other hand, the changeover valve is moved into the other position, in which its inlet 9 is connected to the outlet 16, then the temperature limiting valve 13 has no function.

Whereas FIG. 1 illustrates the schematic arrangement of the various elements of the valve device, the following figures show views of or sections through a preferred embodiment of the invention. FIG. 2 shows the housing of a sanitary fitting 17 which can be flush-mounted in a wall using lateral lugs 18 with holes in them. The housing of the sanitary fitting 17 contains a receptacle in which a mixer valve 2 is located. A plan view of the mixer valve can be seen in FIG. 2, where the adjusting spindle 19 can be discerned.

The changeover valve, illustrated schematically with reference number 10 in FIG. 1, a mechanical changeover valve, can be seen at the top of FIG. 2. It is possible to fit a handle on this changeover valve too, as on the mixer valve 2 at the bottom of FIG. 2.

The first water duct 7 passes out of the mixer valve inside the housing of the sanitary fitting 17 and leads to one inlet of the changeover valve 10. This water duct, consisting of a simple channel, is not illustrated in FIG. 2, and runs, for example, underneath the plane of the section.

The second water duct passes via the temperature limiting valve 13, which is shown in section in FIG. 2. The temperature limiting valve is arranged transversely relative to the connecting line between the mixer valve 2 and the changeover valve 10. Its structure will now be described with reference to FIG. 3. FIG. 3 shows an enlarged partial section through the sanitary fitting 17. The channel 12 leading to the temperature limiting valve passes on the right in FIG. 3 from above into a transverse hollow chamber, in which the temperature limiting valve 13 is located. The temperature limiting valve 13 contains a base element 20 arranged at the right-hand end of the hollow chamber, and which is secured with the aid of a screw plug 21. An expansion element is located in the base element 20 and acts on a shaft 22 which, depending on the volume of the expansion element, is moved to a greater or lesser degree out of the central hole of the base element 20. A valve head 23 is attached to the front end of the shaft 22 protruding from the base element 20 and is slid on the cylindrical end part 24 of the base element 20. A seal 25 is provided between the outer face of the cylindrical end part 24 and the inner face of the valve head 23. The valve head 23 has a cylindrical outer face, in which a further surrounding seal 26 is inserted in a groove in the region facing away from the base element 20.

The passage into which the temperature limiting valve 13 is inserted tapers by way of an inclined shoulder 27 into a cylindrical region 28 which is closed off from the opposite side of the housing of the sanitary fitting 17 by a further plug 29. The external diameter of the valve head 23 corresponds approximately to the internal diameter of the region 28 of the passage. FIG. 3 illustrates the temperature limiting valve in a condition corresponding to a cold temperature, in which therefore the passage through the second water duct 15 is open. In the region in front of the valve head 23, a channel leads out of the region 28 of the passage with a smaller diameter, transversely to the plane of the drawing. The opening 30 leading to this channel is indicated in FIG. 3.

If water now passes through the channel 12 into the passage for the temperature limiting valve, then it flows past the outer face of the valve head 23, through the intermediate space in the region in front of the valve head 23, from where it passes through the opening 30 into the channel 14. This is of course only the case if the manual changeover valve 10 is in the position in which the inlet in 11 of the changeover valve 10 is connected to the outlet 16.

If the temperature of the water flowing through the channel 12 now rises, then the shaft 22 moves, taking with it the valve head 23, until it moves into the region 28 of the passage. This closes the valve. As the temperature rises yet further, the valve head can be pushed further, without being pressed hard against any valve seat.

The situation just described is illustrated in FIG. 4, and an enlarged view is shown in FIG. 5.

The valve head 23 has in the region of its front face a web 31 with a ring element 32 formed on its free end. This ring element 32 has an external diameter that corresponds approximately to the internal diameter of this front region 28 of the passage. A sealing ring 33 is located in a groove in the outer face of the ring element 32. A compression spring 34 acts on the front face of the ring element 32 facing away from the valve head 23, so pushing the valve head 23 back when the water temperature drops again. It can be seen by comparing FIGS. 3 and 5 that the compression spring 34 is more strongly compressed in the position of FIG. 5 than it is in FIG. 3.

The valve head 23 also has a radial channel 35 running in the axial direction of the valve head between the seal arranged on the outer face of the valve head 23 and the seal 25 arranged on the inner face. This channel therefore leads into the narrow gap between the shaft 24 of the base element 20 and the inner face of the valve head 23. The water can emerge from this narrow region through an axial channel 36 at the front face of the valve head 23. The result of this is that even when the temperature limiting valve is closed, see FIGS. 4 and 5, a small amount of water can still pass through the temperature limiting valve.

If, when starting a showering or bathing process, the user wants to make use of the advantages of the valve device, he switches the changeover valve into the position in which the temperature limiting valve is connected through the changeover valve to the outlet 16. When the feed line is opened, therefore, the cold water that is contained in the pipe first flows out of the outlet 16, and continues to do so until the following water is hot, causing the temperature limiting valve to close the passage through the second water duct 15 more or less completely. Only a small quantity of water now continues to flow through channels 35 and 36, so that water trickles out of outlet 16. The user therefore sees that the outlet 16 is being supplied with water. There is no risk that he will forget the process. In addition, this way of designing the valve head 23 has the advantage that water continues to be supplied, this continuing flow of water being hot. The valve is thus not induced to re-open after a certain time as a result of the valve itself cooling down again. This circumstance could occur if the temperature limiting valve were to close tightly.

We now consider the embodiment illustrated in FIG. 6. Whereas in the embodiment illustrated in FIG. 1 the two water ducts 7, 15 are arranged in front of the changeover valve 10, FIG. 6 shows a modified embodiment, where the changeover valve 10 is arranged the other way round. The inlet to the changeover valve constitutes simultaneously the mixed water inlet 6 of the valve device, and is connected to the mixed water outlet 5 of the mixer valve 2. The two other connections to the changeover valve 9, 11, are connected via the respective water duct 7, to the outlet 16 from the valve device. The mode of operation of this arrangement is the same as in the foregoing embodiment, and is therefore not described again. This connecting system between the water ducts 7, 15 and the valves 2, 10 can be implemented in the same way as in the embodiment illustrated in more detail in FIG. 2 to FIG. 5.

1. Sanitary valve device comprising
a mixed water inlet (6) into the valve device,
an outlet (16) from the valve device,
a changeover valve (10) for changing between two water ducts,
a first water duct (7) of the two water ducts being arranged between the mixed water inlet (6) into the valve device and the outlet (16) from the valve device,
a second water duct (15) of the two water ducts leading from the mixed water inlet (6) via a temperature limiting valve (13) to the outlet from the valve device,
wherein the temperature limiting valve (13) keeps the passage through the second water duct (15) open below a limit temperature, and
at least substantially closes the passage through the second water duct (15) above the limit temperature, and wherein the changeover valve (10) changeably connects the mixed water inlet (6) to the outlet (16), via one of the first water duct and the second water duct.

2. Valve device according to claim 1, wherein the valve device is arranged in a sanitary fitting (17) having a mixer valve (2) whose mixed water outlet (5) is connected to the mixed water inlet (6) of the valve device.

3. Valve device according to claim 1, in which the temperature limiting valve (13) is a mechanically operating valve incorporating an expansion body that is movable with rise in temperature, and which is moved back again when the temperature drops.

4. Valve device according to claim 1, in which the temperature limiting valve (13) does not completely close off flow through the second water duct (15) when in its closed condition.

5. Valve device according to claim 1, in which the two water ducts (7, 15) run separately from one another.

6. Valve device according to claim 1, in which a valve closing face of the temperature limiting valve (13) is an enclosing surface of a cylinder.

7. Valve device according to claim 1, in which the changeover valve (10) incorporates an outlet connected to the outlet (16) from the valve device, and inlets (9, 11) connected to the first water duct (7) and to the second water duct (15) respectively.

8. Valve device according to claim 1, in which the changeover valve (10) incorporates an inlet connected to the mixed water inlet (6), and outlets (9, 11) leading to the first water duct (7) and to the second water duct respectively.

9. (canceled)

10. Valve device according to claim 1, wherein the valve device is arranged in a sanitary fitting (17) having a mixer valve (2) whose mixed water outlet (5) constitutes the mixed water inlet (6) of the valve device.

11. A method to safeguard against temperatures that are too low in a sanitary valve device coupled to a flow of water, comprising:
providing in the sanitary valve device a mixed water inlet (6) into the valve device, an outlet (16) from the valve device, two water ducts between the mixed water inlet (6) and the outlet (16), and a changeover valve (10) for selectively directing flow through one of a first and a second of the two water ducts (7, 15);
arranging a temperature limiting valve (13) in the second water duct (15), and operating the temperature limiting valve (13) so as to keep the passage through the second water duct (15) open to flow below a limit temperature, and substantially closing the passage through the second water duct (15) above the limit temperature; and,
selectively operating the changeover valve (10) to connect the mixed water inlet (6) to the outlet (16), via a selected one of the first water duct and the second water duct.

12. The method of claim 11, comprising arranging the valve device in a sanitary fitting (17) having a mixer valve (2) with a mixed water outlet (5) leading into the mixed water inlet (6) of the valve device.

13. The method of claim 11, wherein the temperature limiting valve (13) is a mechanically operating valve incorporating an expansion body, and further comprising moving the expansion body with rise in temperature, and moving the expansion body back again when the temperature drops.

14. The method of claim 11, comprising operating the temperature limiting valve (13) up to a closed condition that does not completely close off flow through the second water duct (15).
